(19) United States
(12) Patent Application Publication
(10) Pub. No.: US 2007/0119846 A1
(43) Pub. Date: May 31, 2007

(54) THERMOREGULATION SYSTEM FOR HEATED COMPONENTS OF APPARATUS FOR INJECTION MOULDING OF PLASTIC MATERIALS

(75) Inventors: Dario Girelli, Brescia (IT); Peter Dal Bo, Vittorio Veneto (Treviso) (IT)

Correspondence Address: HESLIN ROTHENBERG FARLEY & MESITI PC, 5 COLUMBIA CIRCLE, ALBANY, NY, 12203, US

(73) Assignee: INGLASS S.p.A., San Polo di Piave (Treviso) (IT)

(21) Appl. No.: 11/468,016

(22) Filed: Aug. 29, 2006

(30) Foreign Application Priority Data
Nov. 29, 2005 (IT) TO 2005 A 000841

(51) Int. Cl. H05B 1/02

(52) U.S. Cl. 219/494

(57) ABSTRACT

Described herein is a thermoregulation sistem for heated components (N) of apparatus for injection moulding of plastic materials, equipped with a first heating resistor (R1) and a second heating resistor (R2) with respective thermocouples (TC1, TC2) associated thereto, comprising an electronic control unit (C) for controlling the fail-safe electric supply of the two resistors (R1, R2) according to signals coming from the respective thermocouples (TC1, TC2). The two resistors (R1, R2) are connected independently to the control unit (C), to which the thermocouples (TC1, TC2) are also independently connected.

### FIELD OF THE INVENTION

The present invention relates in general to apparatus for injection moulding of plastic materials, equipped, for introduction of the fluid plastic material into a mould, with heated components, such as hot chambers and injector nozzles.

### STATE OF THE PRIOR ART

Disclosed in the European patent No. EP-B-1252998 is a heated component of this sort, specifically constituted by an injector nozzle, equipped with a first heating resistor and a second heating resistor, operatively associated to which are a first temperature sensor and a second temperature sensor respectively, constituted in particular by thermocouples. The two resistors and the two thermocouples are connected, with the modalities clarified in what follows, to an electronic control unit that controls power supply, selectively to one and/or to the other of the two resistors.

Both resistors are arranged generally along the same zone of the injector nozzle, and at the same radial distance from the melt channel thereof: in this way, a fail-safe function is provided, thanks to which correct operation of the heated component (in the case in point, the injector nozzle) is guaranteed in the event of breakdown of the first resistor or of the corresponding thermocouple, via activation of the second injector with the thermocouple associated thereto, so as to keep the temperature of the injected plastic material at the values set, without any risk of degradation of the moulding process.

Since specific electronic control units for the aforesaid fail-safe solution are not so far available, ordinary control units used for heated components with single resistor and corresponding single thermocouple are currently used. In this case, wiring of the electrified elements corresponds to what is illustrated in the diagram of FIG. 1, where designated by R1 and R2 are the two heating resistors, designated by TC1 and TC2 are the corresponding two thermocouples, and designated as a whole by C is the control unit. As may be seen, the wiring envisages connection in parallel of the two resistors R1, R2 and the connection of just one of the two thermocouples, for example the one designated by TC1, to the control unit C. The other thermocouple TC2 is to be connected to the control unit C only in the case of failure of the first thermocouple TC1.

Clearly, this situation enables only a partial benefit deriving from the use of a fail-safe injector nozzle (or hot chamber) in so far as, in the case of failure of the thermocouple TC1 or in the event of short circuit of the resistor R1, functional restoring of the heated component (and hence resumption of production) by connecting up the other thermocouple TC2 and activating the other resistor R2 requires an intervention of manual switching.

### SUMMARY OF THE INVENTION

The purpose of the present invention is to overcome said drawback, enabling automatic renewal of the correct operation of the heated component, and thus prevent interruptions in the production activity in the event of failure of one or other of the resistors and/or in the event of breakdown of one or other of the thermocouples, without requiring any human intervention.

Said purpose is achieved thanks to a system of thermoregulation as defined in the preamble of claim 1, characterized by a particular wiring consisting in that each of the aforesaid first and second resistors is connected independently to said control unit and each of the aforesaid first and second thermocouples is connected independently to said control unit.

According to the invention the control unit can include a pair of independent thermoregulators, each connected to a respective resistor and to the corresponding thermocouple, or else a single thermoregulator that is able to manage both of the resistors with the corresponding thermocouples.

### BRIEF DESCRIPTION OF THE DRAWINGS

In the plate of drawings:

FIG. 1 is a diagram that shows the wiring system currently in use, described above with reference to the known art, between a heated component of an apparatus for injection moulding of plastic materials and the corresponding electronic control unit; and

FIG. 2 is a diagram similar to that of FIG. 1, which shows the wiring system according to the invention.

### DETAILED DESCRIPTION OF THE INVENTION

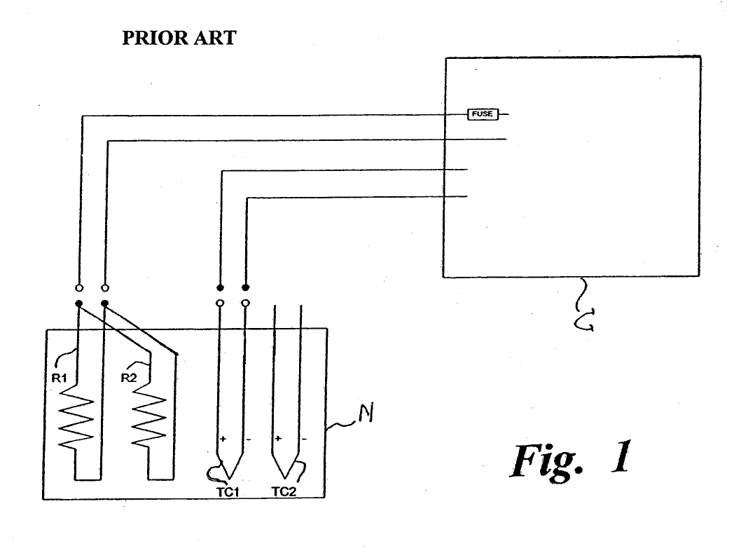

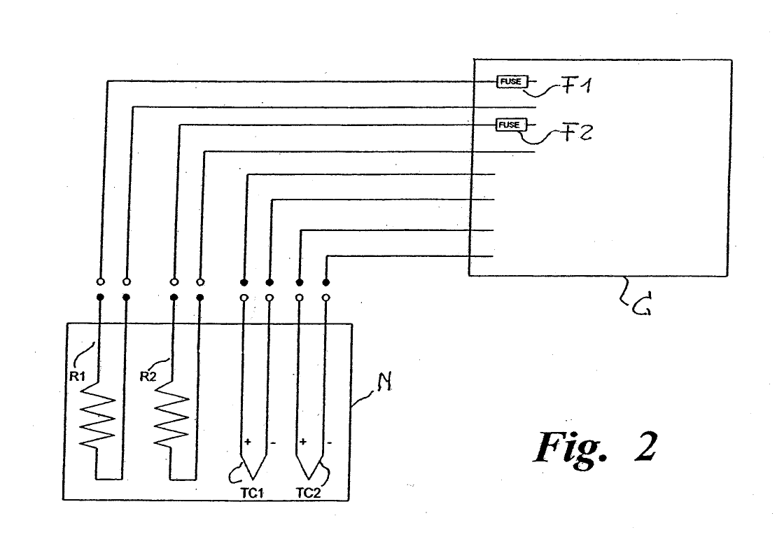

In FIG. 2 the same references are used for the parts already described with reference to the state of the known art illustrated in FIG. 1. The fail-safe heated component N of the injection apparatus, for example an injector nozzle, is equipped with a first heating resistor R1 and a second heating resistor R2, associated to each of which is a respective control thermocouple TC1, TC2. The electrical terminals of the two resistors R1, R2, which are arranged generally along the same zone of the injector nozzle and at the same radial distance from the melt channel thereof, are connected in an independent way to the control unit C via respective pairs of conductors and are protected electrically against possible short circuits by means of respective devices for interruption of the electric power supply, typically constituted by two fuses F1, F2. The two thermocouples TC1, TC2 are also each independently connected, at their corresponding electrical terminals, to the control unit C through respective pairs of conductors.

The control unit C is not represented in detail in so far as it is within the reach of a person skilled in the branch. For the purposes of the invention it is sufficient to clarify that it can include a pair of independent thermoregulators, each operatively associated to a respective resistor and corresponding thermocouple, or else a single thermoregulator that is able to manage the signals coming from both of the thermocouples. The two alternatives differ from one another as regards different dynamics of behaviour in the event of an operating fault of of one of the two resistors, as is clarified in what follows.

In the first case, i.e., in the case where the control unit C incorporates a pair of independent thermoregulators, in the event of failure of a resistor R1, the physical response of the heated component N undergoes a natural variation in the dynamics of the thermal response, which can be detected independently by both of the thermoregulators of the control unit C on the closed loop of the signal coming from the corresponding thermocouple TC1, so that the thermoregulator associated to the other resistor R2 will continue to operate by re-processing the PID parameters for control of said resistor, whilst the second thermoregulator will set itself in an error state.

In the event, instead, of failure of the thermocouple TC1, the thermoregulator associated thereto will signal the error and will set itself automatically in a “slave” state, i.e., at the service of the thermoregulator associated to the functioning thermocouple TC2, continuing to drive the resistor R1, no longer according to its own processing of the PID calculation, but in response to the thermoregulator associated to the functioning thermocouple TC2. In brief, the resistor R1 is in said possible situation automatically controlled by the thermocouple TC2. Likewise, in the event of failure of the thermocouple TC2, the resistor R1 will be automatically controlled by the thermocouple TC1.

In the case, instead, where the control unit C includes a single thermoregulator that is able to manage the information of both of the thermocouples TC1, TC2, in the case where there arises a failure of a resistor R1 the physical response of the heated element N undergoes a natural variation in the dynamics of thermal response, which can be detected by said thermoregulator in closed loop on the signals coming from both of the thermocouples TC1, TC2. The thermoregulator will continue to operate by re-processing the PID parameters for control of the resistor R2, signalling the fault.

In the event of failure of a thermocouple TC1, the thermoregulator will signal the fault and will proceed by processing the PID calculation in closed loop on the measurement of temperature carried out by the functioning thermocouple TC2.

The failure-identification techniques are not herein described in detail, in so far as they do not form the subject of the invention.

Neither will the specific conformation of the thermoregulator or each thermoregulator of the control unit C be described in detail, in so far as it is within the reach of a person skilled in the branch. For the purposes of the present invention it is sufficient to clarify that the thermoregulator or each thermoregulator may comprise input amplifiers of the signals coming from the thermocouples TC1, TC2, said amplifiers being provided at input to a block for acquisition and treatment of the corresponding signals, connected to a block for regulation and control, which is in turn connected to a block for management of the supply of power to the two resistors R1, R2.

It should be noted that, in a possible variant of the invention, the fuses F1, F2 associated to the two resistors R1, R2 could also be connected in parallel to the power-supply device.

1. Thermoregulation system for heated components of apparatus for injection moulding of plastic materials equipped with a first heating resistor and a second heating resistor generally provided at the same zone of said heated component, and with a first temperature sensor and a second temperature sensor comprising thermocouples operatively associated with said first heating resistor and said second heating resistor, respectively, and an electronic control unit connected to said first and second resistors and to said first and second thermocouples for controlling fail-safe electric supply of said resistors according to signals coming from said thermocouples, wherein each of said first and second resistors is connected independently to said control unit, and each of said first and second thermocouples is connected independently to said control unit.

2. The system of thermoregulation according to claim 1, wherein connection between each of said first and second resistors and said control unit includes a respective device for interruption of the electric supply in the event of a short circuit.

3. The system of thermoregulation according to claim 1, wherein said control unit includes two independent thermoregulators.

4. The system of thermoregulation according to claim 3, prearranged so that, in the event of failure of the thermocouple connected to one of said two thermoregulators, said thermoregulator automatically sets itself at the service of the other thermoregulator.

5. The system of thermoregulation according to claim 1, wherein said control unit includes a single thermoregulator.
